(19) United States
(12) Patent Application Publication
(10) Pub. No.: US 2025/0249435 A1
(43) Pub. Date: Aug. 7, 2025

(54) METHOD FOR LOADING A PARTICULATE SORBENT MATERIAL

(71) Applicant: JOHNSON MATTHEY PUBLIC LIMITED COMPANY, London (GB)

(72) Inventors: Lucy Jane BARRASS, Cleveland (GB); Mark Alexander KENT, Cleveland (GB); Adrian Tony LAWRENCE, Cleveland (GB)

(21) Appl. No.: 18/855,925

(22) PCT Filed: May 4, 2023
(86) PCT No.: PCT/GB2023/051177

§ 371 Date: Oct. 10, 2024

(30) Foreign Application Priority Data
May 23, 2022 (GB) 2207516.2

(51) Int. Cl. B01J 20/30; B01J 20/02; B01J 20/28

(52) U.S. Cl. CPC B01J 20/3092; B01J 20/0285; B01J 20/28004; B01J 20/28011; B01J 20/28019; B01J 20/2803

(57) ABSTRACT

A method is described for loading a sorbent material, comprising the step of forming a bed of a particulate copper sulphide sorbent in a reaction vessel in an atmosphere containing oxygen, wherein the particulate copper sulphide sorbent comprises greater than 5% by weight of copper sulphide powder having a D₅₀ average particle size in the range of 5 to 100 μm and having an average CuS crystallite size, as determined by XRD, in the range 25-60 nm.

This invention relates to a method for loading a particulate copper sulphide sorbent into a vessel in which it is to be used.

Heavy metals such as mercury are found in small quantities in fluid streams such as hydrocarbon or other gas and liquid streams. Mercury, in addition to its toxicity, can cause failure of aluminium heat exchangers and other processing equipment. Therefore, there is a need to efficiently remove these metals from fluid streams. Copper sulphide containing sorbents are used commercially to remove heavy metals from fluid streams, such as hydrocarbon streams in refineries and from natural gas. The reaction for capturing mercury using a copper sulphide sorbent may be depicted as follows:

2 CuS+Hg→Cu₂S+HgS

Copper sorbents are conventionally extruded compositions formed by impregnation of copper salts onto supports or granulated compositions containing copper oxide or copper hydroxycarbonate, that are sulphided to form copper sulphide. For example, WO2009/101429 A1 discloses a method for making an absorbent comprising the steps of: (i) forming a composition comprising a particulate copper compound capable of forming copper sulphide, a particulate support material, and one or more binders, (ii) shaping the composition to form an absorbent precursor, (iii) drying the absorbent precursor material, and (iv) sulphiding the precursor to form the absorbent. The final sulphiding step may be performed in-situ, i.e. in the reaction vessel in which the sorbent is to be used, or ex-situ in a sulphiding vessel and the sulphided sorbent containing copper sulphide subsequently loaded into the reaction vessel in which it is to be used.

Loading a pre-sulphided sorbent into a reaction vessel has the disadvantage that the copper (II) sulphide, even under ambient conditions, can react with oxygen and moisture to form copper sulphites and sulphates. This reduces the effectiveness of the sorbent and can lead to potentially hazardous self-heating during loading of the copper sulphide sorbent into the reaction vessel. In consequence, loading of the copper sulphide sorbents is routinely practiced using an inert atmosphere, typically a nitrogen atmosphere. This has the disadvantage that the operator is required to have a reliable source of a suitable inert gas for the loading of the sorbent into the reaction vessel, and operators engaged in loading activities inside the reaction vessel are required to wear breathing apparatus. The alternative of sulphiding in situ also has disadvantages because it requires a reliable source of suitable sulphiding compounds and an additional step for the operator to perform before the reaction vessel is brought on-line. Therefore, there is a need for a loading method that overcomes these problems.

The Applicant has surprisingly found that if copper (II) sulphide crystals in the sorbent are above a certain size, then the reactions with oxygen and moisture are suppressed and self-heating may be completely avoided.

Accordingly, the invention provides a method for loading a sorbent material, comprising the step of forming a bed of a particulate copper sulphide sorbent in a reaction vessel in an atmosphere containing oxygen, wherein the particulate copper sulphide sorbent comprises greater than 5% by weight of copper sulphide powder having a D₅₀ average particle size in the range of 5 to 100 m and having an average CuS crystallite size, as determined by XRD, in the range 25-60 nm.

The method advantageously allows the operator to load the vessel with the particulate copper sulphide sorbent under air.

The method relates to loading a particulate copper sulphide sorbent into a reaction vessel to form a bed. Such beds, also known as fixed beds, may be configured for axial flow or radial flow. The method may be applied to any axial flow or radial flow reaction vessel. The reaction vessel in the current method is the vessel in which the sorbent is to be used to remove heavy metals from a process fluid. The reaction vessel may be any shape but typically is a cylindrical vessel with domed ends. The vessel may have a length in the range 1 to 15 metres, more typically 2-10 metres. The diameter may be in the range 0.5 to 6 metres. The bed may therefore have a volume in the range of about 1.5 to 300 m³. Self-heating is a particular problem for large beds above 10 m³.

Desirably, the sorbent is loaded in the vessel as one or more fixed beds according to the present method. More than one bed may be loaded in the reaction vessel and the beds may be the same or different in composition.

The reaction vessel is typically installed vertically, such that there is an upper end and a lower end. The loading may be performed by pouring the particulate copper sulphide sorbent though an opening in the upper end, or by conveying the sorbent through the opening from outside the vessel. The loading may be by sock loading, pneumatic transfer loading, loading via CHEP bins, from bags or drums, or via a loading tube or chute. Such loading techniques are known, but unlike the prior methods, the present method does not require the reaction vessel to be first filled with an inert gas, such as nitrogen.

The loading is performed in an oxygen-containing atmosphere. This includes atmospheres comprising or consisting of air or air diluted with an inert gas such as nitrogen. The method also includes loading in plant nitrogen that has an oxygen content, typically of 1-5% by volume. The method may also be used for oxygen-enriched air atmospheres. Preferably the oxygen content of the atmosphere containing oxygen is in the range of 1 to 25% by volume.

The loading method may be performed at ambient temperature, for example at a temperature in the range of 5 to 40° C., but more preferably in the range 10 to 30° C.

The relative humidity may be up to 100%.

The method requires a particulate copper sulphide sorbent. By “sorbent” we include both “absorbent” and adsorbent”. The copper sulphide sorbent used in the method has a relatively large copper (II) sulphide (CuS) crystallite size. The Applicants have found that this crystallite size is larger than conventional copper sulphide sorbents formed using a pre-sulphiding step, for example as described in the aforesaid WO2009/101429. Rather, the sorbents useful in the present method are made using a pre-formed copper sulphide.

The pre-formed copper sulphide used to prepare the sorbent may be sourced commercially or may be prepared by a number of methods. Suitable methods include roasting of copper or a copper compound with elemental sulphur, solvothermal processes, hydrothermal processes (e.g. microwave irradiation), electrodeposition techniques, precipitation of copper sulphide from solution, sulphiding of copper compounds using hydrogen sulphide, by electron irradiation, or by a mechanochemical process in which powdered copper metal is mixed with elemental sulphur under conditions that cause the elemental copper and elemental sulphur to react to form one or more copper sulphides. Such methods are described in the Materials Research Bulletin, vol 30, no 12, p1495-1504, 1995. The copper sulphide includes copper (II) sulphide, CuS, (covellite) and may contain sub-stoichiometric copper sulphides, e.g. of formula Cu₂₋ₓS where x is 0-1, such as Cu₉S5 (digenite). Copper sulphides high in CuS are preferred, and the overall S:Cu atomic ratio of the particulate copper sulphide in the sorbent is preferably ≥0.8, more preferably 0.9, most preferably 0.95. Desirably, essentially all of the sulphided copper in the sorbent is in the form of copper (II) sulphide, CuS. The copper sulphide in the sorbent is provided as a powder that is combined with other components of the sorbent. The copper sulphide powder in the sorbent has average particle size, i.e. D₅₀, in the range 5-100 m, preferably 5-50 m. The average particle size or term volume-median diameter D[v,0.5], sometimes given as D50 or D0.5, is defined by Dr Alan Rawle in the paper “Basic Principles of Particle Size Analysis” available from Malvern Instruments Ltd, Malvern, UK (www.malvern.co.uk), and is calculated from the particle size analysis which may conveniently be effected by laser diffraction according to ISO13320, for example using a Malvern Mastersizer™.

The average crystallite size of the CuS in the particulate copper sulphide sorbent is in the range 25 to 60 nm, preferably 30 to 55 nm. The average crystallite size may be determined by X-ray Diffraction (XRD) using known methods. A particularly suitable method uses Bruker D8 Advance XRD equipment with Cu K wavelength 1.5406 Angstroms with Lynxeye PSD detection. Rietveld refinement and Scherrer line broadening are common methods of XRD crystallite size determination. Though either method may be used, Rietveld considers the whole pattern and is preferred.

The copper sulphide content of the sorbent is 5% by weight or higher. While the copper sulphide content may be in the range 5 to 55% by weight (expressed as CuS), we have found that materials with low levels of copper sulphide can be as effective in capturing heavy metals as conventional sorbent materials. Therefore, the copper sulphide content of the sorbent may be in the range 5-45% by weight, preferably 5 to 25% by weight, more preferably 5 to 20% by weight, (expressed as CuS). This is despite the large CuS crystallite size, which might have been expected to produce a sorbent with poorer performance as a consequence of the lower CuS surface area.

The sorbent may further comprise a support material and/or one or more binders. The support material provides a surface on which the copper sulphide particles may be dispersed, and the one or more binders hold the particles together and provide the desired strength to endure the loading process and subsequent use.

The particulate copper sulphide sorbent may contain 20 to 60% by weight of a particulate support material to disperse the copper sulphide particles. The particulate support material, where present, may be any inert support material suitable for use in preparing sorbents. Such support materials include alumina, metal-aluminate, silica, silicon carbide, titania, zirconia, zinc oxide, aluminosilicates, zeolites, metal carbonate, carbon, or a mixture thereof. The particulate support materials are desirably oxide materials such as alumina, titania, zirconia, silica and aluminosilicate, or mixtures of two or more of these. Hydrated oxides may also be used, for example alumina trihydrate or boehmite. Particularly suitable particulate support materials are aluminas and hydrated aluminas, especially alumina trihydrate. The particulate support material may have a D₅₀ particle size in the range 1-100 μm, especially 5-20 μm.

The particulate copper sulphide sorbent may contain one or more binders to bind the particles of copper sulphide, and optionally support material, together in the sorbent. Binders that may include clay binders such as bentonite, sepiolite, attapulgite clays; cement binders, particularly calcium aluminate cements such as ciment fondu; and organic polymer binders such as cellulose binders, or a mixture thereof. Particularly strong sorbent particles may be formed where the binder is a combination of a cement binder and a clay binder. In such materials, the relative weights of the cement and clay binders may be in the range 3:1 to 1:5.

Alternatively, the binder may consist of a particulate calcined, rehydratable alumina, which usefully can function both as a binder and as a support material. By the term “calcined, rehydratable alumina” we mean a calcined amorphous or poorly crystalline transition alumina comprising one or more of rho-, chi- and pseudo gamma-aluminas. Such aluminas are capable of rehydration and can retain substantial amounts of water in a reactive form. Calcined, rehydratable aluminas are commercially available, for example as “CP alumina powders” available from BASF AG. They may be prepared, for example, by milling gibbsite (Al(OH)₃), to a 1-20 micron particle size followed by flash calcination for a short contact time as described in U.S. Pat. No. 2,915,365. In addition to gibbsite, amorphous aluminum hydroxide and other naturally found mineral crystalline hydroxides such as Bayerite and Nordstrandite or monoxide hydroxides, such as Boehmite (AlOOH) and Diaspore may be also used as a source of the calcined, rehydratable alumina.

The copper sulphide in the sorbent may be distributed throughout the sorbent particles or may be provided as a coating on the surface of a shaped particulate support as a so-called eggshell layer. The method has been found to be particularly suitable for the eggshell sorbents, despite the fact that more of the copper sulphide is exposed to the oxygen-containing atmosphere.

Especially suitable methods of preparing the particulate copper sulphide sorbents that may be used in the loading method of the present invention are disclosed in WO2015092359 A1, WO2015092360 A1, WO2016193659 A1 and WO2016193660 A1.

Thus, sorbents suitable for use in the loading method of the present invention may be prepared by one of the following methods:

### Method 1

(i) mixing together a particulate copper sulphide material, a particulate support material and one or more binders,
(ii) shaping the mixture, and
(iii) drying the shaped mixture to form a dried sorbent.

### Method 2

(i) mixing together a particulate copper sulphide material and a particulate calcined, rehydratable alumina,
(ii) shaping the mixture, and
(iii) drying the shaped mixture to form a dried sorbent.

### Method 3

(i) mixing together a particulate support material and one or more binders to form a support mixture,
(ii) shaping the support mixture by granulation in a granulator to form agglomerates,
(iii) coating the agglomerates with a coating mixture powder comprising a particulate copper sulphide and one or more binders to form a coated agglomerate, and
(iv) drying the coated agglomerate to form a dried sorbent.

### Method 4

(i) forming agglomerates comprising a particulate support material,
(ii) coating the agglomerates with a coating mixture powder comprising a particulate copper sulphide and a particulate calcined, rehydratable alumina to form a coated agglomerate, and
(iii) drying the coated agglomerate to form a dried sorbent.

The copper sulphide sorbent used in the method is particulate. Particles of the sorbent may be by pelleting, extruding or granulating. Hence, sorbent pellets may be formed by moulding a powder composition, generally containing a material such as graphite or magnesium stearate as a moulding aid, in suitably sized moulds, e.g. as in conventional tableting operation. Alternatively, sorbent extrudates may be formed by forcing a suitable composition and often a little water and/or a moulding aid as indicated above, through a die followed by cutting the material emerging from the die into short lengths. For example, extrudates may be made using a pellet mill of the type used for pelleting animal feedstuffs, wherein the mixture to be pelleted is charged to a rotating perforate cylinder through the perforations of which the mixture is forced by a bar or roller within the cylinder: the resulting extruded mixture is cut from the surface of the rotating cylinder by a doctor knife positioned to give extruded pellets of the desired length. Alternatively, sorbent granules, in the form of agglomerates, may be formed by mixing a powder composition with a little liquid, such as water, insufficient to form a slurry, and then causing the composition to agglomerate into roughly spherical granules in a granulator. Suitable granulator equipment is available commercially.

The particulate copper sulphide sorbent preferably has a length and width in the range 1 to 25 mm, with an aspect ratio (longest dimension divided by shortest dimension)≤4. Spherical granules with a diameter in the range of 1 to 15 mm are most preferred.

Where the copper sulphide is present in an eggshell layer, the thickness of the layer on the surface of the support may be in the range 1 to 2000 μm (micrometres), but preferably is in the range 1-1500 micrometres, more preferably 1-500 micrometres. Thinner layers make more efficient use of the applied copper.

A particularly preferred sorbent comprises a particulate pre-formed copper sulphide coated, along with a clay binder and optionally an alumina or alumina trihydrate, as a surface layer of 1 to 1000 μm thickness on the surface of agglomerates formed from a particulate hydrated alumina support material, bound together with a cement binder and a clay binder.

The methods used for the preparation of the sorbents do not require a sulphiding step because the copper sulphide on the sorbent is pre-formed with the desired characteristics. It has been found by the Applicant the prior art preparation methods employing a sulphiding step, produce copper sulphide materials with CuS average crystallite sizes smaller and therefore more prone to the unwanted side reactions and self-heating in oxygen-containing atmospheres than those suitable for the present invention.

The sorbents used in the method of the present invention are less prone to self-heating than prior art sorbents that are shaped and then pre-sulphided. The susceptibility of a material to self-heating may be established using a number of methods. There is a significant amount of open literature available on methodologies suitable for testing the self-heating properties of copper sulphide-based materials, which can in the worst cases lead to serious hazards from fire and toxic SO₂ gas generation. See for example F. Rosenblum, J. Nesset and P. Spira, CIM Bulletin vol. 94, No 1056, pp. 92-99. Specialist testing for self-heating is available commercially.

Once the sorbent has been loaded into the reaction vessel according to the present method, the sorbent may be used to treat both liquid and gaseous fluid streams containing heavy metals, in particular fluid streams containing mercury and/or arsenic.

The invention is further described by reference to the following Examples and Figures, in which:

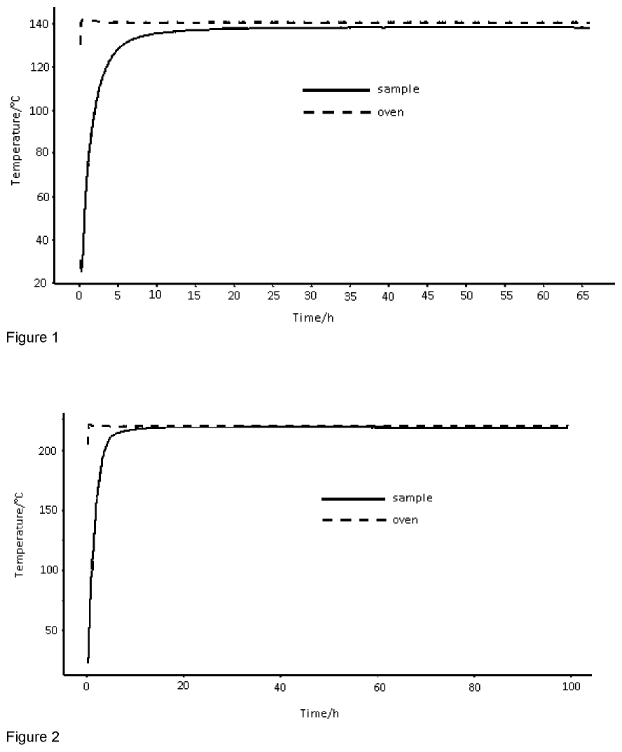

FIGS. 1, 2 and 4 are plots of temperature against time for a sorbent material useful in the method of the present invention; and

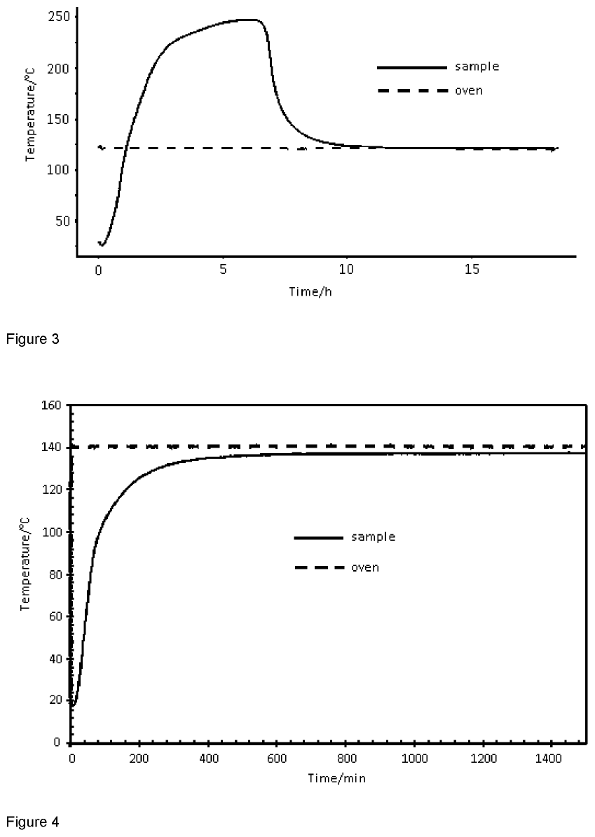

FIG. 3 is a plot of temperature against time for a comparative example.

### EXAMPLE 1: PREPARATION OF SORBENT

Material A. A core-shell copper sulphide adsorbent was prepared on hydrated alumina agglomerates according to the method of WO2015092359 A1, using a commercially sourced reagent-grade copper (II) sulphide powder (99.8% wt CuS) having a D₅₀ of 20.8 μm. The copper sulphide content of the sorbent was 12.6% by weight. The average CuS crystallite size of the sorbent was 41 nm.

The copper sulphide crystallite size was determined by XRD using a Bruker D8 Advance X-Ray Diffractometer. The powdered sample was pressed into a sample holder and loaded into the instrument. Parallel beam (Göbel mirror) optics were used, In terms of software, Bruker EVA was used for phase identification and Topas was used for Rietveld refinement. The diffractometer conditions were as follows:
X-Ray Cu Kα Wavelength 1.5406 Å with Lynxeye PSD detection.
Starting 2 Theta 10°
Finish 2 Theta 130°
Step 0.022°
Step time, see 1
X-Ray current, mA 40
X-Ray voltage, kV 40

Rietveld analysis (Bruker Topas v6) was used to determine copper sulphide crystallite size. Rietveld refinement of powder XRD data starts with a calculated pattern based on symmetry information and an approximate structure from the ICDD PDF 4+ structure database. Rietveld refinement then uses a least squares minimisation to compare every observed point to the calculated plot and refines the calculated structure to minimise the difference.

Material B. For comparison, a sorbent precursor was prepared according to the method of WO2009/101429 A1 by forming a granulated mixture of copper hydroxycarbonate, alumina trihydrate, calcium aluminate cement and attapulgite clay. The resulting product was then sulphided by treatment with a gas containing hydrogen sulphide until the reaction was essentially complete. The copper sulphide content of the sorbent was 44% wt. The average CuS crystallite size of the sorbent was 22 nm.

### EXAMPLE 2: SELF-HEATING TEST

The self-heating test consisted of a heat accumulation test in a 1 litre wire basket, corresponding to the standard test for substance classification according to UNECE: Recommendations on the Transport of Dangerous Goods—Model Regulations (Rev. 21) and CLP Regulation (EC) No 1272/2008 on the classification, labelling and packaging of substances and mixtures.

A 1 L cubic wire basket was filled with the sample and heated to a temperature in the range 120 to 220° C. for 72 h in an oven. The sample in the oven was exposed to a flow of air which was bubbled through water at 70° C. in order to ensure a high humidity, before the air was fed into the oven. The temperature of the sample was recorded. If a sample temperature increases more than 60 degrees Centigrade above the air temperature at an air temperature of 140° C., the sample material would be classified as “Self-Heating” within GHS and for Transport (Class 4.2). Other oven temperatures were also used to further quantify sensitivity to self-heating with higher temperatures being more likely to trigger self-heating.

The test results are shown in Table 1 and in FIGS. 1-3.

TABLE 1

| | | | Temperature rise | |
|---|---|---|---|---|
| Test | Sample | Test conditions | due to exotherm | |
| 1 | Material A | 140° C. oven temperature. | 0° | C. |
| | | Sample mass 1023 | | |
| | | g at 1.02 g/ml. 2 L/min | | |
| | | flow rate. Gas = air. | | |
| 2 | Material A | 220° C. oven temperature. | 0° | C. |
| | | Sample mass 1023 | | |
| | | g at 1.02 g/ml. 2 L/min | | |
| | | flow rate. Gas = | | |
| | | nitrogen for first 9 h | | |
| | | 55 min then air. | | |
| 3 | Material B | 120° C. oven temperature, | 127.3° | C. |
| | | sample weight = | | |
| | | 1077 g at 1.08 g/ml. 2 L/min | | |
| | | flow rate. Gas = air | | |

Plots for material A when tested at 140° C. and 220° C. are depicted in FIGS. 1 and 2 respectively. In the case of the 220° C. test, the test was initiated with the sample being exposed to a flow of humidified nitrogen for the first 9 hours to achieve stabilisation before the gas was switched to air. The plots show that in both the 140° C. test and the 220° C. test, there was no exotherm observed and so no self-heating for Material A.

For comparison, the plot for Material B is shown in FIG. 3 which involved an oven temperature of 120° C. The plot shows a significant temperature rise for material C of 127.3° C. when exposed to these conditions due to self-heating. Potential to self-heat is exacerbated by higher temperatures.

### EXAMPLE 3: PREPARATION OF SORBENT

Material C. A core-shell copper sulphide adsorbent was prepared on hydrated alumina agglomerates according to the method of WO2015092359 A1, using a commercially sourced reagent-grade copper (II) sulphide powder (99.8% wt CuS) having a D50 of 14.6 μm. The copper sulphide content of the sorbent was 16.1% by weight. The CuS crystallite size of the sorbent was 46 nm when measured by XRD.

### EXAMPLE 4: SELF-HEATING TEST

The sorbent from Example 3 (Material C) was tested in a heat accumulation test in a 1 litre wire basket (100 mm diameter cube), corresponding to the standard test for substance classification according to UNECE: Recommendations on the Transport of Dangerous Goods—Model Regulations (Rev. 21) and CLP Regulation (EC) No 1272/2008 on the classification, labelling and packaging of substances and mixtures. In this case the test was conducted at ambient/lower humidity.

The test results are shown in Table 2 and in FIG. 4.

TABLE 2

| | | | Temperature rise |
|---|---|---|---|
| Test | Sample | Test conditions | due to exotherm |
| 4 | Material C | 140° C. oven temperature. | 0° C. |
| | | Sample mass 1065 g at 1.07 | |
| | | g/ml. Circulating oven | |
| | | of ca. 120 L capacity. | |
| | | Gas = air. | |

The sample did not show any signs of exothermic activity. The results demonstrate that materials having the claimed properties may be safely exposed to air during loading.

1. A method for loading a sorbent material, comprising the step of forming a bed of a particulate copper sulphide sorbent in a reaction vessel in an atmosphere containing oxygen, wherein the particulate copper sulphide sorbent comprises greater than 5% by weight of copper sulphide powder having a D₅₀ average particle size in the range of 5 to 100 mm and having an average CuS crystallite size, as determined by XRD, in the range 25-60 nm.

2. The method according to claim 1, wherein the bed is configured for axial flow or radial flow.

3. The method according to claim 1, wherein the reaction vessel is a cylindrical vessel.

4. The method according to claim 3, wherein the reaction vessel has a length in the range 1 to 15 metres, and a diameter in the range 0.5 to 5 metres.

5. The method according to claim 1, wherein the bed has a volume above 10 m³.

6. The method according to claim 1, wherein the reaction vessel is installed vertically, such that there is an upper end and a lower end, and the loading is performed by pouring the particulate copper sulphide sorbent though an opening in the upper end, or by conveying the sorbent through the opening from outside the vessel.

7. The method according to claim 1, wherein the atmosphere containing oxygen comprises air or air diluted with an inert gas.

8. The method according to claim 1, wherein the loading method is performed at a temperature in the range of 5 to 40° C.

9. The method according to claim 1, wherein the average crystallite size of the CuS in the particulate copper sulphide sorbent is in the range 30 to 55 nm.

10. The method according to claim 1, wherein the copper sulphide content of the particulate copper sulphide sorbent is in the range 5-45% by weight, (expressed as CuS).

11. The method according to claim 1, wherein the particulate copper sulphide sorbent furthers comprise a support material and/or one or more binders.

12. The method according to claim 1, wherein the copper sulphide in the particulate copper sulphide sorbent is distributed throughout the sorbent particles or is provided as a coating on the surface of a shaped particulate support as an eggshell layer.

13. The method according to claim 1, wherein the particulate copper sulphide sorbent is in the form of spherical granules with a diameter in the range of 1 to 15 mm.

14. The method according to claim 1, wherein the copper sulphide is present in an eggshell layer on a particulate support material and the thickness of the layer on the surface of the support material is in the range 1 to 2000 μm.

15. The method according to claim 1, wherein the particulate copper sulphide sorbent comprises a particulate pre-formed copper sulphide coated, along with a clay binder and optionally an alumina or alumina trihydrate, as a surface layer of 1 to 1000 μm thickness on the surface of agglomerates formed from a particulate hydrated alumina support material, bound together with a cement binder and a clay binder.

16. The method according to claim 1, wherein the copper sulphide content of the particulate copper sulphide sorbent is in the range 5 to 25% by weight, (expressed as CuS).

17. The method according to claim 1, wherein the copper sulphide content of the particulate copper sulphide sorbent is in the range 5 to 20% by weight, (expressed as CuS).
